(19) United States
(12) Patent Application Publication
(10) Pub. No.: US 2021/0243557 A1
(43) Pub. Date: Aug. 5, 2021

(54) A NAVIGATION DEVICE AND A NAVIGATION COMMUNICATION SYSTEM

(71) Applicant: DUBLIN CITY UNIVERSITY, Dublin 9 (IE)

(72) Inventors: Conor Brennan, Dublin (IE); Derek Molloy, Dublin (IE); Martin Trainor, Dublin (IE)

(21) Appl. No.: 17/049,548

(22) PCT Filed: Apr. 23, 2019
(86) PCT No.: PCT/EP2019/060350

§ 371 Date: Oct. 21, 2020

(30) Foreign Application Priority Data
Apr. 23, 2018 (GB) 1806573.0

(51) Int. Cl. H04W 4/024; G01S 1/70; G01S 1/74; G01S 5/02; G08B 7/06; H04W 4/02; H04W 4/029

(52) U.S. Cl. CPC H04W 4/024; G01S 1/7034; G01S 1/751; H04W 84/18; G08B 7/066; H04W 4/023; H04W 4/029; G01S 5/02213

(57) ABSTRACT

The invention provides a navigation device comprising a docking portion configured to securely adhere to a surface and a unit having at least one of a visual, an audio or tactile indicator. The present invention provides a device which the user attaches to a wall or door or ground surface entered on the way into a building. A number of fixed devices then assist the user to retrace their route out of the building. In addition, the device can be configured to transmit essential information to a user located outside the building. The devices can also be configured to form a novel navigation communication system.

### FIELD

The present disclosure relates to a device that assists users to navigate within a hazardous environment or building with limited visibility. The disclosure also relates to a navigation communication system.

### BACKGROUND

Fire fighters need to enter a burning building to extinguish a fire and/or to rescue people who have become trapped by fire. The conditions within a burning building range from limited to no visibility, including elevated temperatures. Conditions within a burning building can be very harsh and deteriorate very quickly for the firefighter.

The firefighters can only enter the burning building wearing full personal protective equipment, including self-contained breathing apparatus (SCBA). The SCBA provides a limited air supply. The minimum number allowed in a breathing apparatus team is two firefighters. The first fire fighter in the team is known as the team leader. The team leader is responsible for safely leading the team into and out of the building. This is commonly known in the fire brigade as path-finding.

When fire fighters enter the burning building they are trained in navigating procedures. The team leader has to mentally landmark the route on the way in to safely lead the team back out of the building again. Fire fighters are trained in this manner because the dense smoke makes visibility practically impossible.

The problem is that firefighters can become disorientated in this harsh environment when exiting the building, resulting in the team becoming lost within the building. The self contained breathing apparatus provides only a limited air supply. If the fire fighters do not make it out in time their air supply will deplete with fatal results. Numerous patent publications exist in the art to overcome the problems, such as those disclosed in WO2014/143711, WO2016/198703, U.S. Pat. No. 5,850,172, US2004/0212514; U.S. Pat. Nos. 6,690,288, 6,317,047 and US2008/0282961. However none provide an effective navigation device and navigation communication for use by firefighters.

It is an object of the invention to provide a navigation device to overcome at least one of the above mentioned problems.

### SUMMARY

According to the invention there is provided, as set out in the appended claims, a navigation device comprising a docking portion configured to securely adhere to a surface and a sealed unit having at least one of a visual, an audio or a tactile indicator.

The present invention seeks to provide a solution to aforementioned problem by providing a device which the user attaches to a wall, floor or door surface entered on the way into a building easily and securely. A number of fixed devices then assist the user to retrace their route out of the building. In addition, the device can be configured to transmit essential information to a user located outside the building, such as indoor positioning, changing internal conditions, body worn sensors and the monitoring of third party safety equipment and systems.

In one embodiment the docking portion comprises an adhesive on one side for securely adhering to the surface.

In one embodiment the docking portion comprises a removable cover to protect the adhesive when not in use.

In one embodiment the adhesive surface comprises one or more ribbed sections.

In one embodiment the adhesive comprises a gel.

In one embodiment the sealed unit comprise a wireless communication module.

In one embodiment the communications module is configured to receive and identify a signal emitted in the vicinity of the device.

In one embodiment the emitted signal is from a sensor or passive device assigned to a user.

In one embodiment the unit is configured to identify a location of the user with respect to the location of the navigation device.

In one embodiment the docking portion comprises a handle adapted to facilitate positioning of the device during deployment.

In one embodiment the cooperating unit comprises and actuator button to initiate operation of the navigation device.

In one embodiment the visual indicator comprises a light source shaped as an appropriate indicator to point in a direction of safety.

In one embodiment the docking portion and the unit are configured to mechanically cooperate with each other in different orientations.

In one embodiment the docking portion and the unit are integrally formed.

In one embodiment the docking portion comprises at least three notches dimensioned to receive a finger of a user to enable the device to be secured to the device.

In one embodiment the unit comprises an environmental sensor module configured to monitor one or more environmental conditions.

In one embodiment the environmental conditions are transmitted to a central location.

In one embodiment the unit is configured with a speaker adapted to output an audio warning or beacon.

In one embodiment the unit is configured with a light source adapted to operate in the infrared spectrum. Suitably the light source is identifiable to a user having a thermal imaging camera (TIC).

In another embodiment there is provided a navigation system comprising a plurality of navigation devices and a controller module to configure the plurality of devices in sequence to generate a path to aid a user exit a building or structure.

In one embodiment there is provided a mesh network of units wherein each unit is configured with low-power low data rate radios such that each unit is communicates with the central controller by a series of hops along a plurality of units back to the central controller.

In one embodiment the mesh network comprises an OpenThread protocol such that when one unit fails the OpenThread protocol automatically reconfigures the plurality of units to maintain the mesh network back to the central controller.

In one embodiment the controller is configured to execute one or more algorithms to provide enhanced proximity sensing and tracking of a crew member based on one or more wireless signals.

In one embodiment the at least one unit is configured with a proximity sensing means such that when a crew member is proximate to the unit a signal is sent from the unit to the central controller.

In one embodiment the range of the proximity sensing can be calibrated from the central controller or the unit.

In one embodiment the central controller is configured to execute one or more algorithms to provide a search mode wherein if a crew member requests a rescue a proximity sensing threshold for each unit is lowered the central controller.

In one embodiment the device will emit an audible sound that will assist the user in locating it in limited visibility.

In one embodiment the device can be set to emit a different sound for different users on different routes. This will assist the user to distinguish the sound applicable to their path out of the building, to avoid any confusion.

In one embodiment the device will communicate with the last device positioned, to give an audible sound which will number the next device in sequence, such is as 1, 2, 3, 4, 5, etc. This will assist the user to know how close he/she is to the final exit.

In one embodiment the device will contain a light that will assist the fire-fighter in locating it in limited visibility.

In one embodiment the user will wear a wrist band, which will vibrate when in close proximity to the device. This will assist the fire-fighter in locating it in limited visibility.

In one embodiment the user will wear a wrist band, which will give an audible sound when pointed in the direction of the device. This will assist the fire-fighter in locating it in limited visibility.

In one embodiment the device will transmit information to an external user, each time a device is attached onto a surface. This will give the external user information on the number of devices established internally.

In one embodiment the device will be fitted with a sensor, which will transmit data to the user externally. This data includes (but does not exclude others), compartment temperature, humidity, toxic gas concentration and onset of flashover conditions.

In one embodiment the device will be fitted with a thermal imaging camera which will transmit images to the user externally.

In one embodiment the device will be identifiable by heads-up technology within the user's facemask or helmet. This will assist the user in locating it in limited visibility.

In one embodiment a user will wear a personalised wrist band. The wrist band will communicate with the device which will transmit information to the external is user. This will give the external user situational awareness data on the indoor location of the user in proximity to the device.

In one embodiment a user will wear a personalised wrist band. The wrist band will communicate with the device which will transmit data on vital signs, such as (but does not exclude others), body temperature, blood pressure and pulse/heart rate. This will provide continual monitoring to the external user for early detection and warning of deteriorating vital signs of the user inside the building.

In a preferred embodiment of the invention the device will communicate with other 3rd party safety equipment such as (but does not exclude others) the contents of the SCBA cylinder, the personal alert safety system (PASS) and personal radios. The device will transmit this information to the user externally.

In a preferred embodiment of the invention the device will capture all incident data and transmit it in real time to users remotely located from the incident. All incident data captured will be saved remotely from the incident.

In a preferred embodiment of the invention the device will contain a door stop.

In a preferred embodiment of the invention the device will be capable of being integrated into a larger incident command system for the entire incident.

In a preferred embodiment of the invention the device will automatically switch on when attached to the door. This will be achieved by depressing a button on the inside of the device when it is pushed against the door.

### BRIEF DESCRIPTION OF THE DRAWINGS

The invention will be more clearly understood from the following description of an embodiment thereof, given by way of example only, with reference to the accompanying drawings, in which:—

FIG. 1 shows how the device is attached to a door and a notch in a building;

FIG. 2 illustrates how the device is attached at a high level when approaching the door from the hinged side;

FIG. 3 illustrates how the device is attached at low level when approaching the door from the leading edge;

FIGS. 4 to 7 illustrates a number of 3D perspective views of a navigation device according to one embodiment of the invention;

FIG. 8 illustrates how to set up the navigation device in use;

FIG. 9 illustrates a number of navigation devices positioned in radio communication with each other to form a navigation communication system;

FIG. 10 illustrates another embodiment of the navigation device according to the invention; and

FIG. 11 illustrates an exploded view of the navigation device shown in FIG. 10.

### DETAILED DESCRIPTION OF THE DRAWINGS

The invention provides a navigation device comprising a docking portion configured to securely adhere to a surface and a cooperating unit having at least one of a visual, an audio or a tactile indicator. The user attaches a device to each door entered or wall or door or suitable surface on their way into the building that is secure. This allows the user to retrace their route back out again by using multiple devices to create a visual, audio or and/or tactile path. The invention can be used by emergency personnel or first responders when they are operating in a hazardous environment, such as a burning building or chemical contamination or in a military environment. Other environments include closed disaster areas or mining applications that can be used underground.

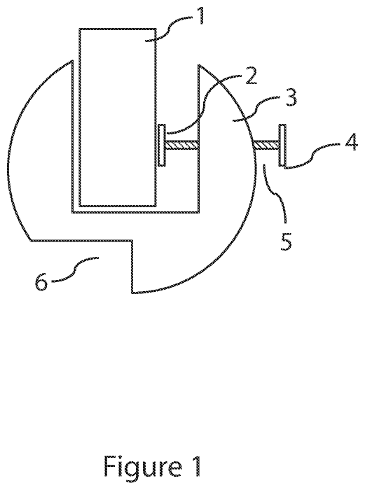

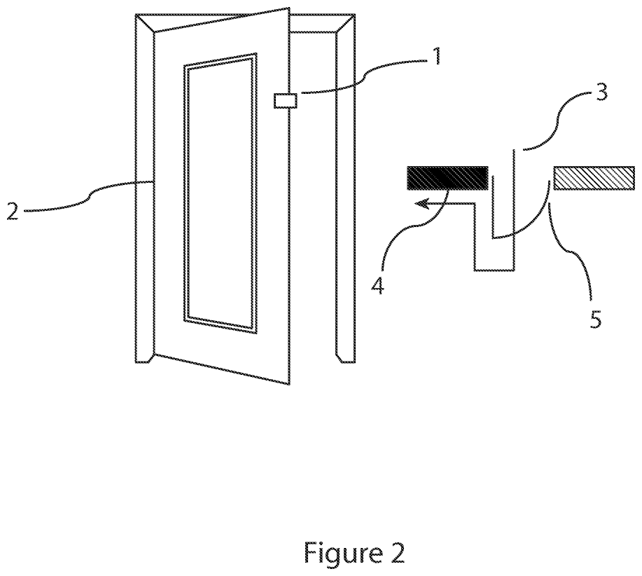

The device can have a clamping mechanism which allows it to be attached and un-attached to a door or other suitable surface in a building, for reuse. The clamping mechanism is capable of attaching to any thickness or type of door, for example as illustrated in FIG. 1. A system for placing the device onto a is door assists the user in finding their way back out of the building. If the door is approached from the hinged side, the device can be attached at a high level, as shown in FIG. 2. If the door is approached from the leading edge, the device can be attached to the bottom of the door, as shown in FIG. 3. Suitable the device will have a notch to indicate or sign post the way out.

The devices attached to each door are used as reference points. These devices will transmit information to a user located outside the building, to monitor the location of users inside the building, relevant to each device. Each device is fitted with sensors, transmitting information to a user located outside the building, to monitor the changing internal conditions.

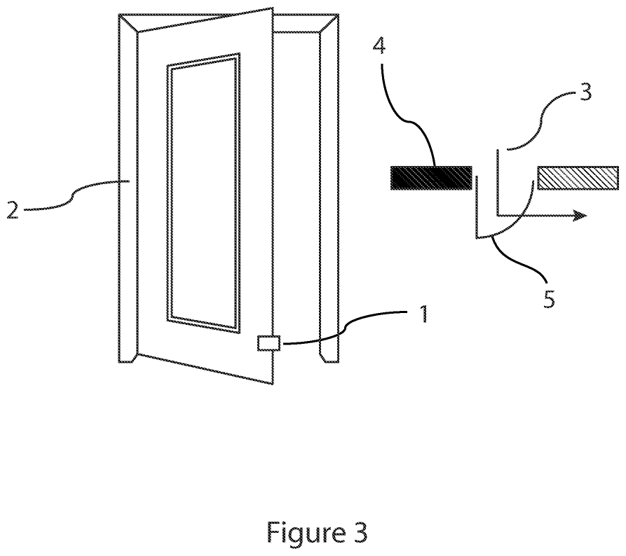

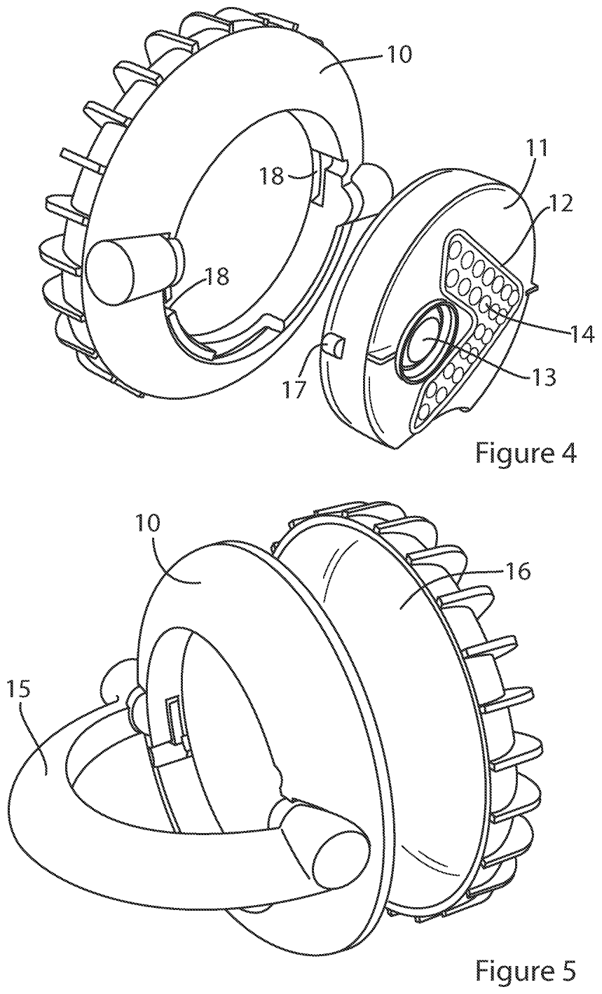

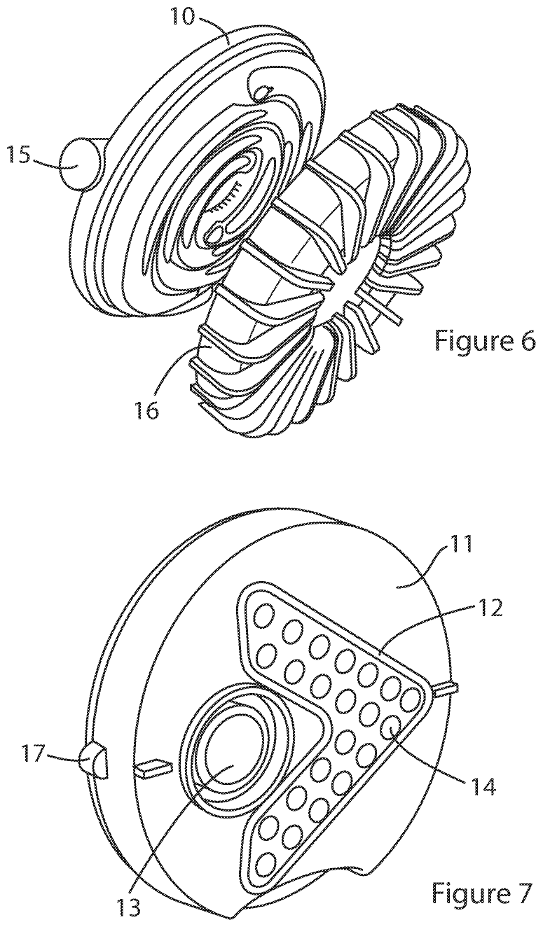

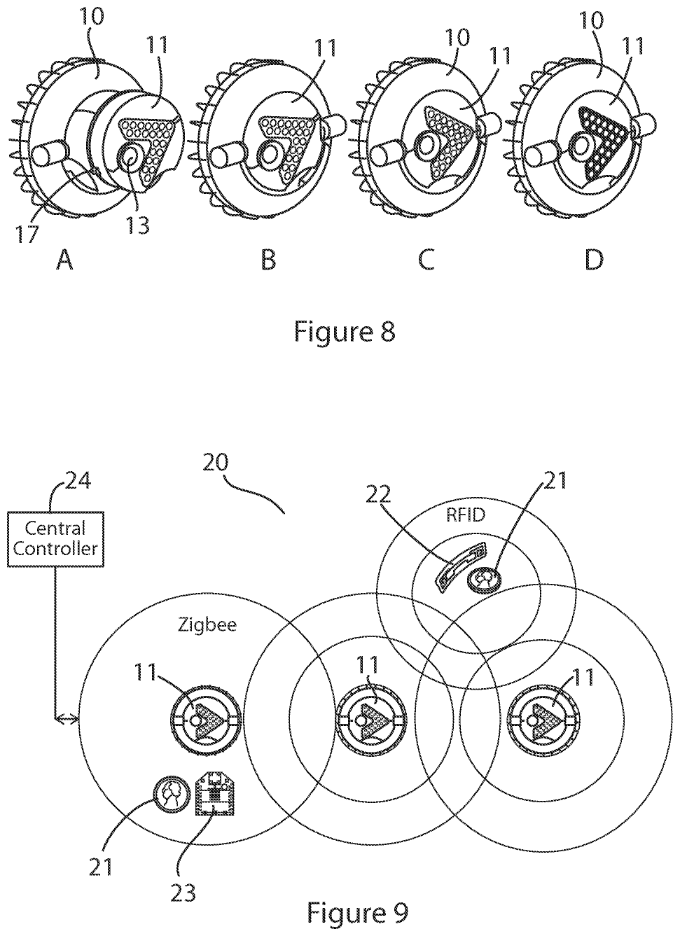

Referring now in detail FIGS. 4 to 7 illustrates a number of 3D perspective views of a navigation device according to one embodiment of the invention. FIG. 4 illustrates a navigation device comprising a docking portion 10 and a unit 11 having at least one of a visual 12, an audio 13 or a tactile indicator 14 and the unit 11 is configured for engaging the docking portion 10, or alternatively the unit 11 and docking portion are integrally formed. The docking portion 10 has a removable cover 16 for protecting a surface of the docking 10 portion where the surface can be an adhesive or sticky surface for securely fixing the docking portion in a building or hazardous environment. The removable cover 16 can be peeled off or embodied as a screw off cover 16. A fold out handle 15 is provided to enable a user position the docking portion to a surface securely. The surface can be a wall, door, floor or ceiling of a building. Once the docking portion 10 is anchored to a surface the unit 11 which is preferably sealed can be slotted into the docking portion in a secure fashion. Alternatively the docking portion and the unit can be integrally formed. FIG. 7 illustrates the unit and comprises a button that can be actuated to turn on the unit, the operation of which is discussed in more detail with respect to FIGS. 8 and 9 below.

The adhesive surface can be ribbed to enable a secure fixing to a desired location. Examples of adhesive is a Pressure Sensitive Adhesive (PSA) or glues is provided in the market, such as those provided by the company Henkel Loctite®. It is worth noting that while an adhesive with any type of suitable glue is envisaged the docking station can be configured with any suitable gripping or adhering means, such as nail or spike actuated anchors incorporated in the docking station that can be actuated by a user to securely affix to the surface. It will be appreciated that the docking portion and the unit does note require an adhesive. Other materials such as Velcro® or a tied cable strap can also be used to securely fix the docking portion to a surface. For example, the docking portion 10 and/or unit 11 can be adapted to engage with a carabineer clip and can be secured to a cable tie or strap looped in an appropriate fashion around a stairwell or a handle of a door as necessary.

FIG. 8 illustrates how to set up the navigation device in use. As shown FIG. 8a the tabs 17 from the unit can be aligned with corresponding notches 18 in the docking portion. Once the unit 11 and docking 11 portion are clicked into place the unit is activated, as shown in FIG. 8b. The unit can be tested or turned on by simply actuating a button to turn the device on, as illustrated in FIG. 8c. FIG. 8d shows the navigation device operational with a visual sign as a light source set at appropriate spectrum for a user to see in hazardous conditions. The light source can be set or programmed to emit different colours that can colour code different messages to the user. In addition or alternatively the unit can be set to emit an audio sound to distinguish the navigation device. For example the audio signal emitted could be ‘DEVICE 4’ that would tell the user which device they are close to. The docking and unit can be configured with pre-determined messages which assist the user in navigating. These messages include, but are not limited to:
Landmark
Door
Searched
Hazard
Assistance required

A colour code on the unit can be configured to be emitted for each assigned is message. These messages can also be transmitted to a remote location and displayed to a user on a GUI relaying information about the device. The devices can be fixed sequentially where each device can act as an audio bacon to tell the user where they are relative to the next beacon, for example the lower the number the closest to an exit or safety.

FIG. 9 illustrates a number of navigation devices positioned in radio communication with each other, indicated generally by the reference numeral 20. Each unit 11 is sealed and comprises a wireless communication module that can transmit and receive information. The communications module is configured to receive and identify a signal emitted in the vicinity of the device. The emitted signal is from a sensor 23 or passive device assigned to a user 21. The unit is configured to identify a location of the user with respect to the location of the nearest navigation device. For example a first responder or firefighter 21 has a wearable sensor 22. The wearable sensor 22 can be a RFID tag that identifiers the user which is sensed by the navigation device. The unit can have a processor and the sensed signal information is processed to identify and determine where the user is proximate to the unit. Each unit 11 comprises an environmental sensor module configured to monitor one or more environmental conditions at the site where the device is located. This environmental information can be relayed back to a user or a central controller 24.

It will be appreciated that a microcontroller and a radio of the unit 11 can communicate with the central controller 24 that can relay control information to an Entry Control Officer (ECO). A technical problem arises is the reliability of the wireless link. Radio signals rapidly degrade as a unit 11 is placed and a firefighter progresses further into a building. This is especially the case for large multi storey concrete structures. To address this problem the navigation system uses a mesh network in conjunction with low-power low data rate radios. This means that each unit 10 communicates with the central controller, not directly, but by a series of hops along a chain of units 11 all the way back to the central controller 24. Each individual hop between units 11 is only over a small distance and is thus more reliable.

Suitably the navigation system shown in FIG. 9 uses the IEEE 802.15.4 radio standard which has been developed to explicitly support low power low-data-rate communications between energy-constrained devices (where long battery life is of more importance than sending large streams of data). 802.15.4 is a mature technology which uses frequency bands at 2.4 GHz and at sub 1 GHz (868 MHz in Europe, 915 MHz in the USA). Another key advantage is that 802.15.4 allows the use of mesh networking technology. In order for the set of units 11 to be organised into an effective network one must address higher layer issues such as routing of information, that is identifying paths by which data can be successfully sent from a unit 11 to the central controller 24. A key challenge is that the network must require minimal setup, and be robust, that is capable of re-configuring itself in the event that some nodes or units 11 are lost during operation.

The navigation system employs a solution called OpenThread which is designed to tackle many of the problems facing the development of emerging Internet of Things networks. OpenThread works by allowing 802.15.4 radios to self-organise into a mesh network, each radio having a designated role within the network, such as a data router (which passes packets along the network) or a network leader (which organises the network). The mesh network allows for each radio to communicate with any other radio in range (the range is of the order of up to 10 m at 2.4 GHz, but closer to 30 m at sub 1 GHz), thus creating a rich web of possible routes for data transfer. This allows for a greater level of redundancy in communications as alternative routes can be found to send messages to the central controller 24 in the event of a given unit 11 being destroyed.

The network is self-organising and self-healing. In contrast to existing networking protocols, such as Zigbee, the OpenThread network allows for the network to seamlessly recover from the loss of a network-vital device such as a network leader unit. If a leader unit is destroyed another unit gets promoted to take its place and the network continues to function. Thus, there is no single is point of failure.

As shown in FIG. 9 suitably each member 21 of a fire-crew will also wear a micro-controller and thus act as a (mobile) node in the network during operation. Each unit 11 communicate with fire-crew members 21 in radio range and, by identifying when the received signal strength exceeds a pre-set threshold, can identify when the fire-crew member is physically close to the unit (for example within 1 to 2 metres). When this happens the unit 11 is configured to send an alert the fire-crew (using lights and sound) and a message can be automatically sent to the central controller 24 updating the ECO with the crew members 21 progress in real time. The central controller 24 can be in the form of, or connected to, a tablet device that can visually the position and progress of each crew member 21 in a building.

Another advantage of the OpenThread protocol is that the data being sent to the central controller 24 or tablet can be seamlessly routed to the wider Internet through the use of a border router connected to the Cloud or third party. OpenThread exists as an open-source code base. In order to send proximity alerts robust signal strength thresholds must be identified that indicate the physical closeness to a device. These must be calibrated to eliminate the possibility of false-positives (i.e. incorrectly alerts at other units 11 that are within radio range (circa 10 m), but not “close” (1 m to 2 m)). Proximity alerts must then be routed effectively through the network and properly acknowledged. Another challenge lies in the interfacing of the micro-controller in each unit 11 with external electronic devices needed to alert the crew as they pass. Suitably the use of high lumen LED lighting can be employed, some of which will be infra-red and thus visible to crew members 21 equipped with hand-held infrared viewers as well as high output piezo sounders which do not require a diaphragm interface with the surrounding air.

The fixed units 11 which are laid along a route can be considered a communication ‘umbilical cord’ making up a temporary network, which starts from the point of entry (externally) and penetrates deep into the building. This is communication ‘umbilical cord’ permits the short hop of information back along the units 11 out to the central controller 24 which provides a bi-directional communication network. This is an important distinction as opposed to prior art systems that use an ‘outside in approach’ which has proved problematic. In other words the deeper prior art systems penetrate into the building it becomes more difficult to relay the information back out again in one large hop.

The advantage of this reliable communications ‘umbilical cord’ is that it can be used to provide real time information back out to the central controller 24 that can be relayed to an Incident Commander.

A second operational parameter to be reported to the central controller 24 over the ad-hoc network 20 is data about each team member 21. This data can comprise health information (e.g. heart rate, carcinogen exposure) as well as operational information (e.g. in-tank oxygen pressure). This data is collected by sensors 22, 23 worn by each team member 21 and communicated wirelessly to the closest unit 11 in the network as the team member 21 passes nearby. This data is then sent over the ad-hoc network 20 back to the central controller 24. Appropriate actions can then be taken in real time by the Incident Controller.

In addition to the low-power low-data rate radio, each unit 11 can be configured with a plurality of environmental sensors interfaced to a microcontroller or microprocessor. The sensors can continually sense the environment in the vicinity of each unit 11. The collected environmental data at each unit 11 can be transmitted over the ad-hoc network 20 to the central controller 24. Suitable sensors that can be employed are temperature, gas, smoke and movement sensors.

The detection of sudden spikes in temperature at a given unit 11 will allow the central controller 24 to pro-actively advise each crew member 21 that their exit route has been compromised and that an alternative path needs to be found. The central controller 24 can execute an algorithm to generate the next best exit path from a building.

The detection of movement, using for example passive infra-red (PIR) motion detectors, will allow the central controller 24 to advise the crew members that there may be civilians present at a location proximate the unit 11 that a movement detection has taken place.

Many of the problems discussed above about loss of signal as the units 11 penetrate deeper into the building are equally applicable to voice communications (i.e. hand-held radios). The communications ‘umbilical cord’ of the network 20 can be utilised to provide backup data message communications. For example in situations where, traditional voice communications prove to be unreliable it is possible to enable the user to communicate by sending short data messages from a list of presets that are then logged on each unit 11 which can then be visually displayed or transmitted to proximate crew members 21. These messages can include one or more of the following:
Emergency: Firefighter down, Air pressure low, Trapped, Evacuation, Structural collapse
Assistance required: Casualty found, Access locked, Hose management
Situational updates: Casualties Found, On way out, Change in level up, Change of level down, At seat of fire, Fighting fire, Fire extinguished, Conditions changing, Hazard identified
Water regulation: No supply, Increase pressure, Decrease pressure

The network 20 hereinbefore described is configured to execute one or more algorithms to provide enhanced sensing and tracking based on wireless signals. One of the main features of each unit 11 is proximity sensing, that is when the system notes that the fire crew 21 is proximate to a unit 11 and sends this information to the central controller 24. Proximity sensing is calibrated to only occur when a crew member 21 is very close (circa 1 m to 1.5 m) to a unit 11. This is deemed to occur when the radio signal received from the fire crew member 21 to the unit 11 is above a pre-set threshold level. This is successful as radio signal strength initially falls off rapidly with distance but then degrades more is slowly. Using a lower radio signal threshold would result in the potential triggering of multiple false positive proximity messages which would suggest the crew member 21 is “close” to multiple units 11 at once. Nonetheless, while these lower strength radio signals are not useful in uniquely determining proximity, they are useful in helping the central controller 24 monitor the location of the fire-crew members 21 as members 21 move between units 11 on their return route. For example, the system monitors and records the radio signal strength from the entire fire crew members 21 to the units as each member 21 makes their way into the building. This monitoring takes place in the background and will not feature, as it is not of direct immediate relevance. This particular pattern of recorded signals is directly determined by the particular path that the crew members 21 have taken. By monitoring the radio signals received at the various units 11 as the crew return it is possible using a predictive algorithm to make an informed estimate as to whether the crew 21 are somewhere on the correct path (in which case the radio signal levels at the various units 11 should be broadly consistent with those observed on the way in, albeit with some random variation caused by, for example, body shadowing) or whether they have left the path (in which case the radio signals will be statistically significantly different). In this way it is possible to tell whether a crew remain on track between units (i.e. between individual proximity alerts) and to send an alert to crew members 21 to alert a member before they stray too far from the correct path.

In another embodiment an algorithm can be executed to implement a search mode. If a crew member 21 needs to be rescued they will request that the system enter search mode. In this mode the proximity threshold for each unit 11 will be significantly lowered by the central controller 24. Therefore each unit 11 that is within radio contact with the fire-crew member 21 that requested the search mode will report them as being close (regardless of whether the signal is strong or weak). Given that the maximum radio range of these devices is around 15 m to 20 m this will give the rescue party vital information as to where the lost crew-members are (in the sense of being within 15 m-20 m of a finite number of identified units). A rescue party will thus be able to move quickly to the identified units and start their search from there.

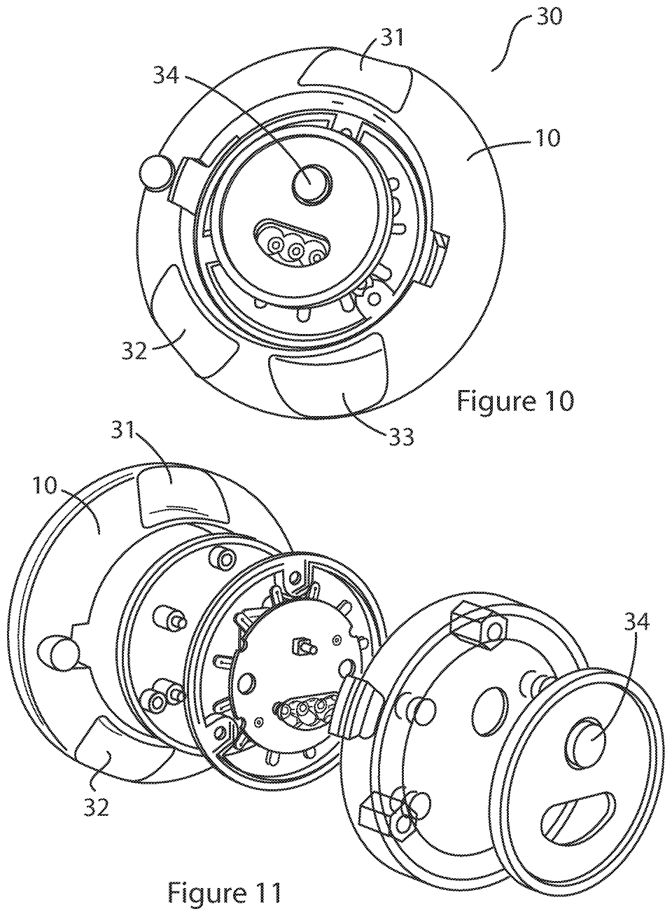

FIGS. 10 and 11 illustrates an alternative embodiment of the navigation device according the invention indicated by reference numeral 30. FIG. 10 shows the docking portion 10 comprises at least three notches 31, 32, 33 dimensioned to receive a finger of a user to enable the device to be secured to the device. No handle is required to secure the device to a surface. The docking portion 10 can be affixed to a surface in a similar manner described above with respect to FIGS. 4 to 7. In this embodiment, the three notches resemble the design of a blowing ball, in that it can only be picked up in one way. The notches 31, 32, 33 ensures the unit is inserted in the correct orientation into the docking portion. It can be located on a surface. A raised nut 34 is positioned to signpost the direction out. FIG. 10 embodiment is for a left hand search another is needed for a right hand search (nut reversed to the other side). It will be disguisable with a different colour and a raised ‘IR’ or ‘L’ on the nut. The user, for example a firefighter, can then on touch find the direction to safety. FIG. 11 shows an exploded view showing the various components making up the button. A clear or transparent cover can be provided to allow the LED lights to be visible. The electronics are housed within the clear cover and a backing piece. Between the backing piece and the clear cover is a waterproof gasket. This is all secured together using a number of screws in a sealed arrangement.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described but may be varied in both construction and detail.

1. A navigation device comprising a docking portion configured to securely attach to a surface or securing means and a cooperating unit having at least one of a visual, an audio and/or tactile indicator, wherein the unit comprises a wireless communication module in a sealed arrangement and the module is configured to receive and identify a signal emitted in the vicinity of the device.

2. The navigation device of claim 1 wherein the docking portion comprises an adhesive on one side for securely adhering to the surface.

3. The navigation device of claims 1 and 2 wherein the docking portion comprises a removable cover to protect the adhesive when not in use.

4. The navigation device as claimed in claim 2 or 3 wherein the adhesive surface comprises one or more ribbed sections.

5. The navigation device as claimed in claim 2, 3 or 4 wherein the adhesive comprises a gel.

6. The navigation device as claimed in any preceding claim wherein the emitted signal is from a sensor or passive device assigned to a user.

7. The navigation device as claimed in any preceding claim wherein the sealed unit is configured to identify a location of the user with respect to the location of the navigation device.

8. The navigation device as claimed in any preceding claim wherein the docking portion comprises a handle adapted to facilitate positioning of the device during deployment.

9. The navigation device as claimed in any preceding claim wherein the cooperating unit comprises an actuator button to initiate operation of the navigation device.

10. The navigation device as claimed in any preceding claim wherein the visual indicator comprises a light source shaped as an appropriate indicator to point in a direction of safety.

11. The navigation device as claimed in any preceding claim wherein the docking portion and the unit are configured to mechanically cooperate with each other in different orientations.

12. The navigation device as claimed in any preceding claim wherein the docking portion and the unit are integrally formed.

13. The navigation device as claimed in any preceding claim wherein the docking portion comprises at least three notches, each notch dimensioned to is receive a finger of a user to enable the unit to be secured to the device.

14. The navigation device as claimed in any preceding claim wherein the unit comprises an environmental sensor module configured to monitor one or more environmental conditions.

15. The navigation device as claimed in claim 14 wherein the environmental conditions are transmitted to a central controller.

16. The navigation device as claimed in any preceding claim wherein the unit is configured with a speaker adapted to output an audio warning or a beacon signal.

17. The navigation device as claimed in any preceding claim wherein the unit is configured with a light source adapted to operate in the infrared spectrum.

18. A navigation system comprising a plurality of navigation devices as claimed in any of the preceding claims and a central controller adapted to configure the plurality of units in sequence to generate a path to aid a user or crew member exit a structure.

19. The navigation system as claimed in claim 18 comprising a mesh network of units wherein each unit is configured with a low-power low data rate radio such that each unit communicates with the central controller by a series of hops along a plurality of units back to the central controller.

20. The navigation system as claimed in claim 19 wherein the mesh network comprises an OpenThread protocol such that when one unit fails the OpenThread protocol automatically reconfigures the plurality of units to maintain the mesh network back to the central controller.

21. The navigation system as claimed in any of claims 18 to 21 configured to execute one or more algorithms to provide enhanced proximity sensing and tracking of a crew member based on one or more wireless signals.

22. The navigation system as claimed in any of claim 21 wherein at least one unit is configured with a proximity sensing means such that when a crew member is proximate to the unit a signal is sent from the unit to the central controller.

23. The navigation system as claimed in any of claim 21 or 22 wherein the range of the proximity sensing can be calibrated from the central controller or the unit.

24. The navigation system as claimed in any of claims 18 to 23 configured to execute one or more algorithms to provide a search mode wherein if a crew member requests a rescue a proximity sensing threshold for each unit is lowered the central controller.

25. The navigation system of claim 24 wherein if a unit is within radio contact with the crew member that requested the search mode the unit will report to the central controller that the crew member is in close proximity.

26. The navigation system as claimed in any of claims 18 to 25 wherein the central controller is adapted to monitor and record the radio signal strength from the crew members relative to the units making a path into the building and mapping a pattern based on the received radio signals.

27. The navigation system as claimed in claim 26 wherein the central controller is configured to monitor the units as each crew member exits the building and map a particular pattern of recorded signals the central controller is configured to execute a predictive algorithm to generate an informed estimate as to whether the crew members are on the correct path by correlating with the mapped pattern generated when the crew member entered the building.
